(19) United States
(12) Patent Application Publication
(10) Pub. No.: US 2022/0385819 A1
(43) Pub. Date: Dec. 1, 2022

(54) OPTICAL UNIT AND SMARTPHONE

(71) Applicant: Nidec Corporation, Kyoto (JP)

(72) Inventors: Kazuhiro SAZAI, Kyoto (JP); Naofumi HORIO, Kyoto (JP)

(21) Appl. No.: 17/749,640

(22) Filed: May 20, 2022

(30) Foreign Application Priority Data
May 25, 2021 (JP) 2021-087888

(51) Int. Cl. H04N 5/232; H04N 5/225

(52) U.S. Cl. CPC H04N 5/23287; H04N 5/2254; H04N 5/23258

(57) ABSTRACT

An optical assembly includes a fixed body, a movable body movably arranged with respect to the fixed body, a support mechanism that supports the movable body, and a swing mechanism that swings the movable body with respect to the fixed body. The movable body includes an optical element having an optical axis and a holder that holds the optical element, the holder includes a bottom portion and a side portion, the support mechanism supports the bottom portion of the holder, and a bottom surface of the optical element is spaced away from an upper surface of the bottom portion of the holder at a position overlapping the support mechanism in an optical axis direction extending along the optical axis.

### CROSS-REFERENCE TO RELATED APPLICATIONS

The present application claims priority under 35 U.S.C. § 119 to Japanese Patent Application No. 2021-087888, filed on May 25, 2021, the entire contents of which are hereby incorporated herein by reference.

### 1. FIELD OF THE INVENTION

The present disclosure relates to an optical assembly and a smartphone.

### 2. BACKGROUND

Image blur sometimes occurs due to camera shake during capturing of a still image or moving image with a camera. An image stabilization device has been put into practical use to enable clear imaging by preventing such image blur. When a camera shakes, the image stabilization device can remove image blur by correcting the position and orientation of a camera module according to the shake.

Mounting an image stabilization device on a thin smartphone or the like has been studied. In a conventional image stabilization device, a substrate on which an imaging element is mounted is fixed to a focusing unit housing in a housing, so that thickness reduction is achieved.

However, when receiving an impact of falling or the like, the conventional image stabilization device may be greatly damaged, and a camera shake may not be appropriately corrected. In particular, since a movable body is movably arranged with respect to the fixed body, the device may be greatly damaged when the movable body is intensely moved and collides with the surroundings when receiving an impact.

### SUMMARY

An optical assembly according to an example embodiment of the present disclosure includes a fixed body, a movable body movably arranged with respect to the fixed body, a support mechanism that supports the movable body, and a swing mechanism that swings the movable body with respect to the fixed body. The movable body includes an optical element having an optical axis and a holder that holds the optical element, the holder includes a bottom portion and a side portion, the support mechanism supports the bottom portion of the holder, and a bottom surface of the optical element is spaced away from an upper surface of the bottom portion of the holder at a position overlapping the support mechanism in an optical axis direction extending along the optical axis.

A smartphone according to an example embodiment the present disclosure includes the optical assembly described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic perspective view of a smartphone including an optical assembly of the present example embodiment.

FIG. 2 is a schematic perspective view of the optical assembly of the present example embodiment.

FIG. 3A is a schematic view of the optical assembly according to the present example embodiment.

FIG. 3B is a schematic view of the optical assembly according to the present example embodiment.

FIG. 4A is a schematic view of the optical assembly according to the present example embodiment.

FIG. 4B is a schematic view of the optical assembly according to the present example embodiment.

FIG. 5A is a schematic view of the optical assembly according to the present example embodiment.

FIG. 5B is a schematic view of the optical assembly according to the present example embodiment.

FIG. 6A is a schematic perspective view of the optical assembly of the present example embodiment.

FIG. 6B is a schematic perspective view of the optical assembly of the present example embodiment.

FIG. 7 is a schematic exploded perspective view of the optical assembly of the present example embodiment.

FIG. 8 is a schematic exploded view of a movable body and a fixed body in the optical assembly of the present example embodiment.

FIG. 9 is a schematic exploded view of an optical element and a holder in the optical assembly of the present example embodiment.

FIG. 10 is a schematic cross-sectional view taken along line X-X of FIG. 6B.

FIG. 11 is an enlarged view of a part of FIG. 10.

FIG. 12A is a schematic perspective view of the fixed body and a support mechanism in the optical assembly of the present example embodiment.

FIG. 12B is a schematic exploded perspective view of the fixed body and the support mechanism in the optical assembly of the present example embodiment.

FIG. 13A is a schematic perspective view of the holder in the optical assembly of the present example embodiment.

FIG. 13B is a schematic perspective view of the holder in the optical assembly of the present example embodiment.

FIG. 14 is a schematic exploded view of the movable body and the fixed body in the optical assembly of the present example embodiment.

FIG. 15A is a schematic perspective view of the holder in the optical assembly of the present example embodiment.

FIG. 15B is a schematic perspective view of the holder in the optical assembly of the present example embodiment.

FIG. 16 is a schematic exploded perspective view of the optical assembly of the present example embodiment.

FIG. 17 is a schematic cross-sectional view of the optical assembly of the present example embodiment.

FIG. 18A is a schematic perspective view of the optical assembly of the present example embodiment.

FIG. 18B is a schematic perspective view of the optical assembly of the present example embodiment.

FIG. 18C is a schematic perspective view of the optical assembly of the present example embodiment.

FIG. 19 is a schematic cross-sectional view of the optical assembly of the present example embodiment.

### DETAILED DESCRIPTION

Hereinafter, example embodiments of optical assemblies and smartphones according to the present disclosure will be described with reference to the drawings. Note that in the drawings, the same or corresponding elements or features will be denoted by the same reference symbols and description of such parts will not be repeated. Note that in the description of the present application, an X-axis, a Y-axis, and a Z-axis that are orthogonal to one another may be used to facilitate understanding of the present disclosure. Here, it should be noted that the X-axis, the Y-axis, and the Z-axis do not limit the orientation of the optical assembly during use.

An optical assembly of the present example embodiment is suitably used as an optical component of a smartphone.

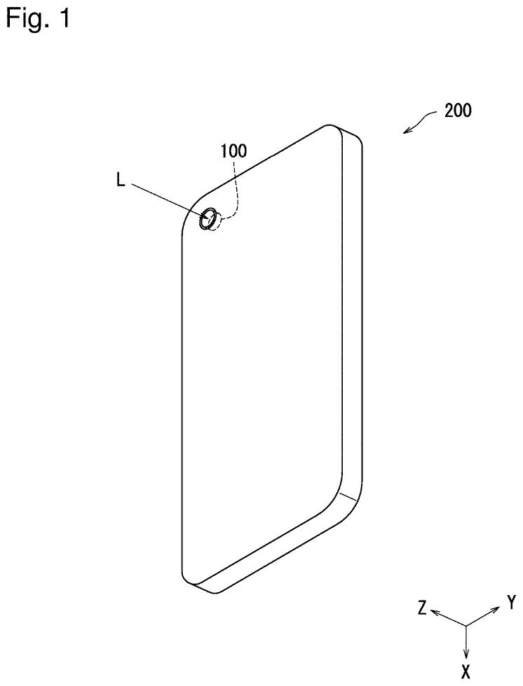

First, a smartphone 200 including an optical assembly 100 of the present example embodiment will be described with reference to FIG. 1. FIG. 1 is a schematic perspective view of the smartphone 200 including the optical assembly 100 of the present example embodiment.

As illustrated in FIG. 1, the smartphone 200 of the present example embodiment includes the optical assembly 100. The optical assembly 100 is incorporated in the smartphone 200 as an example. Light L enters the smartphone 200 from the outside through the optical assembly 100, and a subject image is captured on the basis of the light that enters the optical assembly 100. The optical assembly 100 is used to correct blur of the captured image when the smartphone 200 shakes. Note that the optical assembly 100 may include an imaging element, and the optical assembly 100 may include an optical member that transmits light to the imaging element. Since the smartphone 200 includes the optical assembly 100, shake in the smartphone 200 can be corrected.

The optical assembly 100 is preferably manufactured in a small size. In this manner, the smartphone 200 itself can be downsized, or another component can be incorporated in the smartphone 200 without upsizing the smartphone 200.

Note that the application of the optical assembly 100 is not limited to the smartphone 200, and the optical assembly 100 can be used in various devices such as cameras and videos without particular limitation. For example, the optical assembly 100 may be incorporated in, for example, an imaging device such as a mobile phone with a camera or a drive recorder, or an action camera and a wearable camera incorporated in a moving body such as a helmet, a bicycle, or a radio-controlled helicopter.

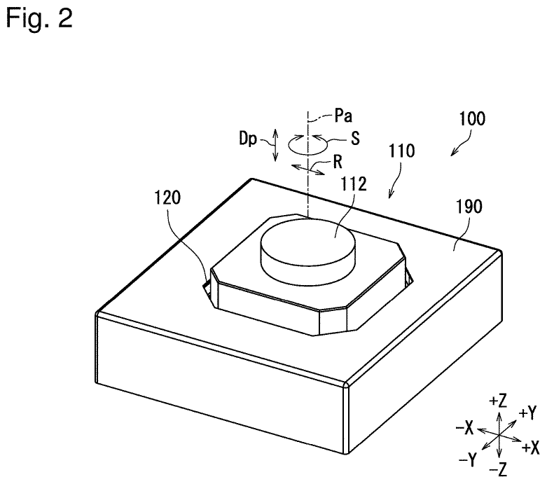

Next, the optical assembly 100 according to the present example embodiment will be described with reference to FIGS. 1 and 2. FIG. 2 is a schematic perspective view of the optical assembly 100 of the present example embodiment.

As illustrated in FIG. 2, the optical assembly 100 includes a movable body 110, a fixed body 120, and a cover 190. The movable body 110 includes an optical element 112 having at least an imaging element. Here, the fixed body 120 is covered with the cover 190.

The optical element 112 has an optical axis Pa. The optical axis Pa extends in the Z direction from the center of a surface on the +Z direction side of the optical element 112. Light along the optical axis Pa enters the optical element 112. A light incident surface of the optical element 112 is arranged on a surface on the +Z direction side of the optical element 112. The optical axis Pa extends in the normal direction with respect to the light incident surface. The optical axis Pa extends in an optical axis direction Dp. The optical axis direction Dp is parallel to the normal line of the light incident surface of the optical element 112.

The direction orthogonal to the optical axis direction Dp is a direction intersecting the optical axis Pa and perpendicular to the optical axis Pa. In the present description, a direction orthogonal to the optical axis Pa may be referred to as a “radial direction”. Of the radial directions, radially outward indicates a direction away from the optical axis Pa. In FIG. 2, a reference sign R indicates an example of the radial direction. Further, a direction of rotation about the optical axis Pa may be referred to as a “circumferential direction”. In FIG. 2, a reference sign S indicates the circumferential direction.

When the movable body 110 is inserted into the fixed body 120 and the movable body 110 is mounted on the fixed body 120, the optical axis Pa of the optical element 112 becomes parallel to the Z-axis direction. When the movable body 110 moves with respect to the fixed body 120 from this state, the optical axis Pa of the optical element 112 swings, and the optical axis Pa is no longer parallel to the Z-axis direction.

Hereinafter, it is assumed that the movable body 110 is not moved with respect to the fixed body 120 and the state in which the optical axis Pa is parallel to the Z-axis direction is maintained. That is, in the description of the shape, positional relationship, operation, and the like of the movable body 110, the fixed body 120, and the like with reference to the optical axis Pa, it is assumed that the optical axis Pa is parallel to the Z-axis direction unless the inclination of the optical axis Pa is specifically described.

The movable body 110 is rotatable about at least a first rotation axis extending in the first direction (for example, the Z direction). The movable body 110 is accommodated in the fixed body 120. Note that in a case where the movable body 110 is accommodated in the fixed body 120, the entire movable body 110 does not need to be located inside the fixed body 120, and a part of the movable body 110 may be exposed or protrude from the fixed body 120.

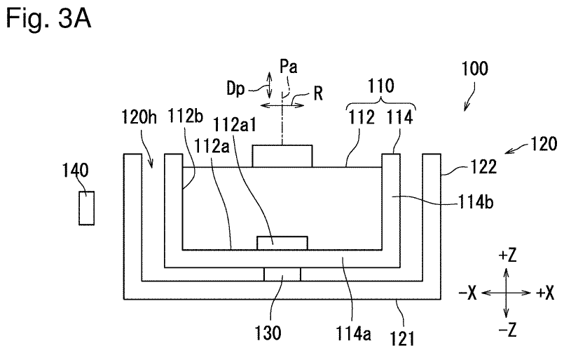

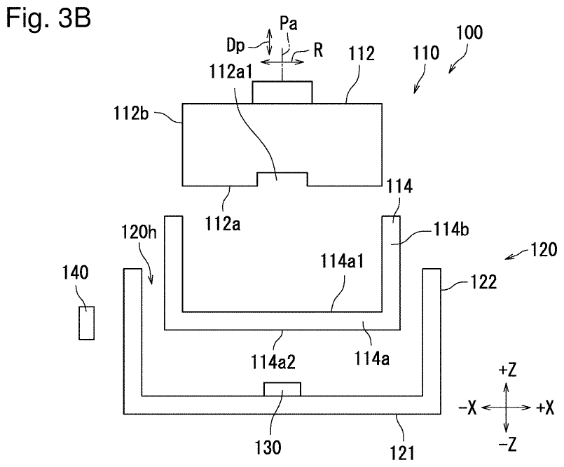

Next, the optical assembly 100 according to the present example embodiment will be described with reference to FIGS. 1 to 3B. FIG. 3A is a schematic view of the optical assembly 100 of the present example embodiment, and FIG. 3B is a schematic exploded view of the optical assembly 100 of the present example embodiment. In FIGS. 3A and 3B, the cover 190 is omitted.

As illustrated in FIGS. 3A and 3B, the optical assembly 100 includes the movable body 110, the fixed body 120, a support mechanism 130, and a swing mechanism 140.

The movable body 110 includes the optical element 112 and a holder 114. The optical element 112 includes at least an imaging element. The optical element 112 is accommodated in the holder 114. The holder 114 holds the optical element 112.

The support mechanism 130 supports the movable body 110 with respect to the fixed body 120. The swing mechanism 140 swings the movable body 110 with respect to the fixed body 120.

In the optical assembly 100 of the present example embodiment, the optical element 112 is located in a manner at least partially separated from the holder 114. In this manner, when the optical assembly 100 receives an impact, a bottom surface of the holder 114 is bent and deformed by the impact, so that the impact can be reduced. Further, the vicinity of the support mechanism 130, which is relatively weak against an impact, of the bottom surface of the holder 114 is preferably bent. However, the bottom surface of the holder 114, even in a case of being bent, does not come into contact with the optical element 112, so that it is possible to reduce the influence of the impact inside the optical assembly 100.

Here, the movable body 110 has a thin substantially rectangular parallelepiped shape. When viewed along the Z-axis, the movable body 110 has a rotationally symmetric structure. The length of the movable body 110 along the X-axis direction is substantially equal to the length of the movable body 110 along the Y-axis direction. Further, the length of the movable body 110 along the Z-axis direction is smaller than the length of the movable body 110 along the X-axis direction or the Y-axis direction.

The movable body 110 includes the optical element 112 and a holder 114. The optical element 112 has a substantially rectangular parallelepiped shape partially including a projection portion. The holder 114 accommodates the optical element 112. The holder 114 has a substantially hollow rectangular parallelepiped shape in which a part of a surface on a first side is opened.

The optical element 112 has a bottom surface 112a and a side surface 112b. Here, the side surface 112b extends in a direction orthogonal to the bottom surface 112a.

The holder 114 has a bottom portion 114a and a side portion 114b. The side portion 114b protrudes in the +Z direction from an outer edge of the bottom portion 114a. The bottom portion 114a of the holder 114 has an upper surface 114a1 and a lower surface 114a2. The upper surface 114a1 of the bottom portion 114a faces the optical element 112. The lower surface 114a2 of the bottom portion 114a faces the fixed body 120.

Here, at least a part of the bottom surface 112a of the optical element 112 is in contact with at least a part of the bottom portion 114a of the holder 114. For this reason, the optical element 112 is supported by the bottom portion 114a of the holder 114.

The fixed body 120 has an opening portion 120h. The movable body 110 is placed inside the fixed body 120. Typically, the movable body 110 is mounted from the outside of the fixed body 120 to the inside of the fixed body 120.

The fixed body 120 has a bottom portion 121 and a side portion 122. The bottom portion 121 extends in an XY plane. The bottom portion 121 has a thin plate shape. The side portion 122 protrudes from the bottom portion 121 in the +Z direction.

The support mechanism 130 supports the movable body 110. The support mechanism 130 is arranged on the fixed body 120. Typically, the support mechanism 130 is arranged on the bottom portion 121 of the fixed body 120.

For example, the support mechanism 130 may be bonded to the fixed body 120 by an adhesive. Alternatively, the support mechanism 130 may be resin-molded integrally with the fixed body 120. That is, the support mechanism 130 and the fixed body 120 may be a single member. When the support mechanism 130 is arranged on the fixed body 120, the support mechanism 130 protrudes from the fixed body 120 toward the movable body 110. For this reason, even in a case where the movable body 110 swings with respect to the fixed body 120, it is possible to suppress collision of the movable body 110 with the fixed body 120.

The swing mechanism 140 swings the movable body 110 with respect to the fixed body 120. With the swing mechanism 140, the movable body 110 swings with respect to the fixed body 120 in a state where a rotation center of the movable body 110 is fixed on the optical axis Pa.

The swing mechanism 140 swings the movable body 110 with respect to the fixed body 120. The swing mechanism 140 can swing the movable body 110 with respect to the fixed body 120 with reference to the rotation center.

In an optical device including the optical element 112, when the optical device is inclined at the time of capturing an image, the optical element 112 is inclined, and the captured image is disturbed. In order to avoid disturbance of the captured image, the optical assembly 100 corrects the inclination of the optical element 112 on the basis of the acceleration, the angular velocity, the shake amount, and the like detected by detection means such as a gyroscope. In the present example embodiment, the optical assembly 100 corrects the inclination of the optical element 112 by swinging (rotating) the movable body 110 in a rotation direction (yawing direction) with the X-axis as the rotation axis, a rotation direction (pitching direction) with the Y-axis as the rotation axis, and a rotation direction (rolling direction) with the Z-axis as the rotation axis.

For example, correction of pitching, yawing, and rolling of the movable body 110 is performed as described below. When a shake in at least one of the pitching direction, the yawing direction, and the rolling direction occurs in the optical assembly 100, the shake is detected by a magnetic sensor (Hall element) (not illustrated), and based on a result of the detection, the swing mechanism 140 is driven to swing the movable body 110. Note that the shake of the optical assembly 100 may be detected using a shake detection sensor (gyroscope) or the like. Current is supplied to the swing mechanism 140 based on a detection result of the shake to correct the shake.

Note that a swing mechanism other than the swing mechanism 140 may swing the movable body 110 with respect to the fixed body 120. The X-axis direction is a direction orthogonal to the optical axis direction Dp in which the optical axis Pa of the optical element 112 extends, and is an axis of rotation in the yawing direction. The Y-axis direction is a direction orthogonal to the optical axis direction Dp in which the optical axis Pa of the optical element 112 extends, and is an axis of rotation in the pitching direction. The Z-axis direction is parallel to the optical axis direction Dp and is an axis of rotation in the rolling direction.

In the optical assembly 100 of the present example embodiment, the bottom surface 112a of the optical element 112 has a region 112a1 separated from the bottom portion 114a of the holder 114. The region 112a1 is located spaced away from the upper surface of the bottom portion 114a of the holder 114 at a position overlapping the support mechanism 130 in the optical axis direction Dp extending along the optical axis Pa. The length in the X direction and the length in the Y direction of the region 112a1 are substantially equal to the length in the X direction and the length in the Y direction of an outer edge of a region supported by the support mechanism 130 in the lower surface 114a2 of the bottom portion 114a of the holder 114.

As described above, the optical assembly 100 of the present example embodiment includes the movable body 110, the fixed body 120, the support mechanism 130, and the swing mechanism 140. The movable body 110 is arranged so as to be movable with respect to the fixed body 120. The support mechanism 130 supports the movable body 110. The swing mechanism 140 swings the movable body 110 with respect to the fixed body 120. The movable body 110 includes the optical element 112 and a holder 114. The optical element 112 has an optical axis Pa. The holder 114 holds the optical element 112.

The holder 114 has a bottom portion 114a and a side portion 114b. The support mechanism 130 supports the bottom portion 114a of the holder 114. The bottom surface 112a of the optical element 112 is located spaced away from the upper surface of the bottom portion 114a of the holder 114 at a position overlapping the support mechanism 130 in the optical axis direction Dp extending along the optical axis Pa.

Since the bottom surface 112a of the optical element 112 is separated from the upper surface 114a1 of the bottom portion 114a of the holder 114 at the position overlapping the support mechanism 130 in the optical axis direction Dp extending along the optical axis Pa, even if the optical assembly 100 receives an impact, collision of the position overlapping the support mechanism 130 in the optical axis direction Dp extending along the optical axis Pa in the upper surface 114a1 of the bottom portion 114a of the holder 114 with the bottom surface 112a of the optical element 112 can be suppressed, and an impact on a contact portion between the bottom portion 114a of the holder 114 and the support mechanism 130 can be reduced.

Note that, in the optical assembly 100 illustrated in FIGS. 3A and 3B, the portion (region 112a1) of the bottom surface 112a of the optical element 112 facing the support mechanism 130 via the bottom portion 114a of the holder 114 is recessed. However, the present example embodiment is not limited to this configuration. The radially outer side of the bottom surface 112a of the optical element 112 may also be recessed further than the portion (region 112a1) facing the support mechanism 130 via the bottom portion 114a of the holder 114.

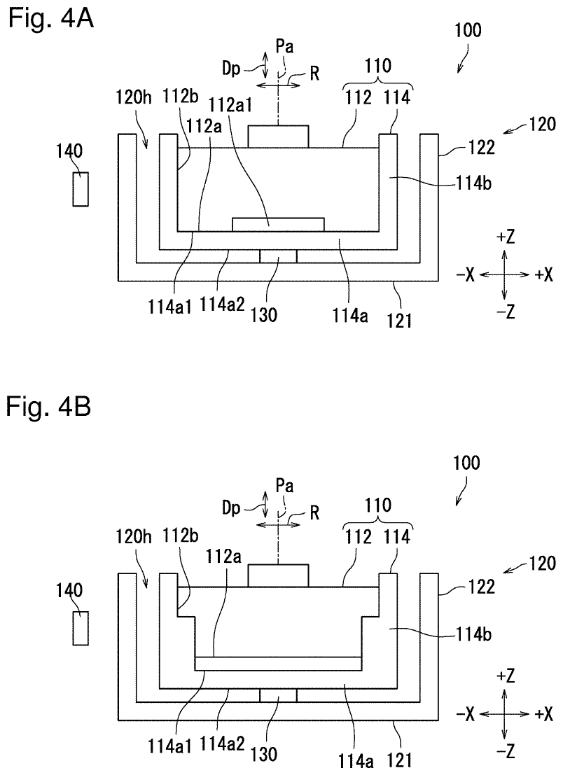

Next, the optical assembly 100 of the present example embodiment will be described with reference to FIGS. 1 to 4A. FIG. 4A is a schematic view of the optical assembly 100 of the present example embodiment.

As illustrated in FIG. 4A, the region 112a1 of the bottom surface 112a of the optical element 112 separated from the bottom portion 114a of the holder 114 is wider than an outer edge of a region of the lower surface 114a2 of the bottom portion 114a of the holder 114 supported by the support mechanism 130. For this reason, the length in the X direction and the length in the Y direction of the region 112a1 are larger than the length in the X direction and the length in the Y direction of an outer edge of a region supported by the support mechanism 130 in the lower surface 114a2 of the bottom portion 114a of the holder 114.

As described above, the bottom surface 112a of the optical element 112 is located spaced away from the upper surface 114a1 of the bottom portion 114a of the holder 114 on the radially outer side from the position overlapping the support mechanism 130 in the optical axis direction Dp.

Since the bottom surface 112a of the optical element 112 is separated from the upper surface 114a1 of the bottom portion 114a of the holder 114 also in a radial direction R from the position overlapping the support mechanism 130 in the optical axis direction Dp extending along the optical axis, even if the optical assembly 100 receives an impact, strong collision of the upper surface 114a1 of the bottom portion 114a of the holder 114 with the bottom surface 112a of the optical element 112 can be suppressed, and an impact on a contact portion between the bottom portion 114a of the holder 114 and the support mechanism 130 can be reduced.

Note that, in the optical assembly 100 illustrated in FIGS. 3A to 4A, the bottom surface 112a of the optical element 112 is partially in contact with the upper surface 114a1 of the bottom portion 114a of the holder 114. However, the present example embodiment is not limited to this configuration. Any region of the bottom surface 112a of the optical element 112 does not need to be in contact with the upper surface 114a1 of the bottom portion 114a of the holder 114.

Next, the optical assembly 100 according to the present example embodiment will be described with reference to FIGS. 1 to 4B. FIG. 4B is a schematic view of the optical assembly 100 according to the present example embodiment.

As illustrated in FIG. 4B, a step is provided on an inner peripheral surface of the side portion 114b of the holder 114. The side surface 112b of the optical element 112 has a step shape. The optical element 112 is supported by a step of the side portion 114b of the holder 114.

The entire bottom surface 112a of the optical element 112 is located spaced away from the upper surface 114a1 of the bottom portion 114a of the holder 114. For this reason, any region of the bottom surface 112a of the optical element 112 is not in contact with the upper surface 114a1 of the bottom portion 114a of the holder 114. Therefore, even if the optical assembly 100 receives an impact, an impact on the contact portion between the bottom portion 114a of the holder 114 and the support mechanism 130 can be reduced since the optical element 112 is separated from the entire surface of the bottom portion 114a of the holder 114.

Further, the support mechanism 130 supports the bottom portion 114a of the holder 114. The optical element 112 is supported by the side portion 114b of the holder 114. Even if the optical assembly 100 receives an impact, an impact on a contact portion between the bottom portion 114a of the holder 114 and the support mechanism 130 can be reduced since the optical element 112 is separated from the bottom portion 114a of the holder 114.

Note that the support mechanism 130 may support a protrusion protruding from the bottom portion 114a of the holder 114 in the optical axis direction Dp. Alternatively, the support mechanism 130 may support a cavity recessed in the optical axis direction Dp on the bottom portion 114a of the holder 114.

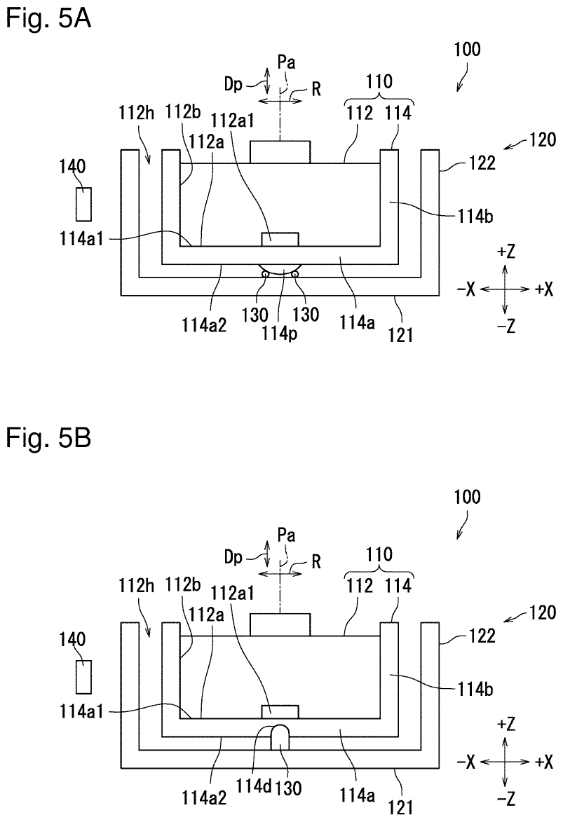

Next, the optical assembly 100 of the present example embodiment will be described with reference to FIGS. 1 to 5A. FIG. 5A is a schematic view of the optical assembly 100 of the present example embodiment.

As illustrated in FIG. 5A, the holder 114 includes the bottom portion 114a, the side portion 114b, and a protrusion 114p. The protrusion 114p is located on the bottom portion 114a of the holder 114. The protrusion 114p protrudes in the −Z direction (optical axis direction Dp) from the bottom portion 114a of the holder 114. For example, the protrusion 114p has a partial shape of a spherical surface. Since the protrusion 114p is provided on the holder 114 different from the optical element 112, the protrusion 114p can be configured with high accuracy.

The support mechanism 130 supports the protrusion 114p of the holder 114. For example, the support mechanism 130 is spherical. The support mechanism 130 is arranged on the fixed body 120.

The bottom portion 114a of the holder 114 has the protrusion 114p protruding in the optical axis direction Dp. The movable body 110 slides with respect to the fixed body 120 via the support mechanism 130. Since the bottom portion 114a of the holder 114 has the protrusion 114p along the optical axis direction Dp, the movable body 110 can slide with respect to the fixed body 120 via the support mechanism 130.

Note that, in the optical assembly 100 illustrated in FIG. 5A, the holder 114 has the protrusion 114p protruding in the optical axis direction Dp. However, the present example embodiment is not limited to this configuration. The holder 114 may have a cavity recessed in the optical axis direction Dp.

Next, the optical assembly 100 according to the present example embodiment will be described with reference to FIGS. 1 to 5B. FIG. 5B is a schematic view of the optical assembly 100 according to the present example embodiment.

As illustrated in FIG. 5B, the holder 114 includes the bottom portion 114a, the side portion 114b, and a cavity 114d. The cavity 114d is located on the bottom portion 114a of the holder 114. The cavity 114d is recessed in the +Z direction from the bottom portion 114a of the holder 114. Since the cavity 114d is provided on the holder 114 different from the optical element 112, the cavity 114d can be configured with high accuracy.

The cavity 114d of the holder 114 corresponds to the support mechanism 130, and the cavity 114d of the holder 114 is engaged with the support mechanism 130. The support mechanism 130 protrudes in the optical axis direction Dp toward the cavity 114d of the holder 114. According to a contact portion between the cavity 114d of the holder 114 and the support mechanism 130, the holder 114 can slide while being supported by the support mechanism 130.

As described above, the bottom portion 114a of the holder 114 includes the cavity 114d recessed in the optical axis direction Dp. The movable body 110 slides with respect to the fixed body 120 via the support mechanism 130. Since the bottom portion 114a of the holder 114 has the cavity 114d along the optical axis direction Dp, the movable body 110 can slide with respect to the fixed body 120 via the support mechanism 130.

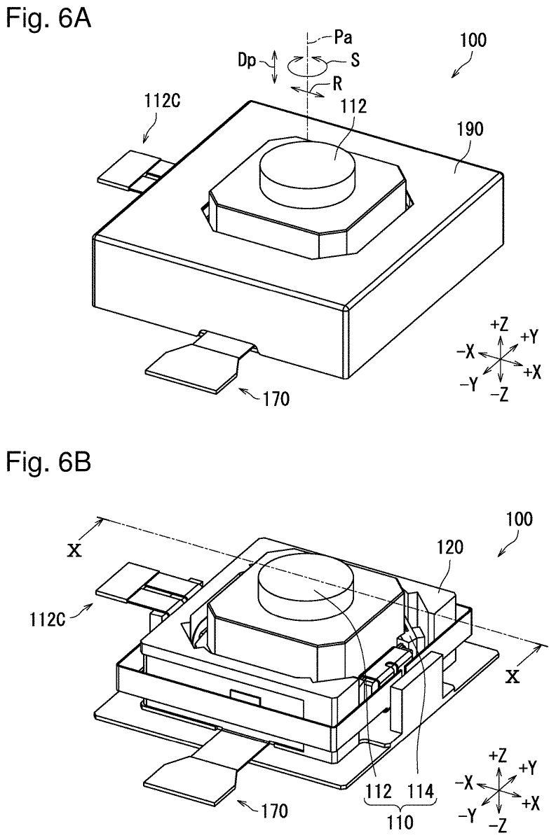

Next, the optical assembly 100 according to the present example embodiment will be described with reference to FIGS. 1 to 6B. FIGS. 6A and 6B are schematic perspective views of the optical assembly 100 of the present example embodiment. In FIG. 6B, the cover 190 is omitted.

As illustrated in FIGS. 6A and 6B, the optical assembly 100 includes the movable body 110, the fixed body 120, a circuit board 170, and the cover 190. The movable body 110 includes the optical element 112 having at least an imaging element and the holder 114. Here, the fixed body 120 is covered with the cover 190. The optical element 112 includes a circuit board 112C. The circuit board 112C and a part of the circuit board 170 extend from the inside to the outside of the fixed body 120 and the cover 190. The circuit board 112C extends in the −X direction with respect to the fixed body 120 and the cover 190. The circuit board 170 extends in the −Y direction with respect to the fixed body 120 and the cover 190.

The fixed body 120 surrounds the movable body 110. The movable body 110 is inserted into the fixed body 120 and held by the fixed body 120. The circuit board 112C may be mounted on an outer surface of the fixed body 120. The circuit board 112C and the circuit board 170 include, for example, a flexible printed circuit (FPC). Typically, the circuit board 170 transmits a signal for swinging the movable body 110. The circuit board 112C transmits a signal obtained in the optical element 112.

The circuit board 112C is electrically connected to the optical element 112. The circuit board 112C outputs an imaging signal obtained by the optical element 112 to the outside.

The movable body 110 is rotatable about at least a first rotation axis extending in the first direction (for example, the Z direction). The movable body 110 and the circuit board 170 are accommodated in the fixed body 120.

As illustrated in FIG. 6B, the movable body 110, the optical element 112, and the holder 114 are included. The optical element 112 is accommodated in the holder 114. The holder 114 holds the optical element 112.

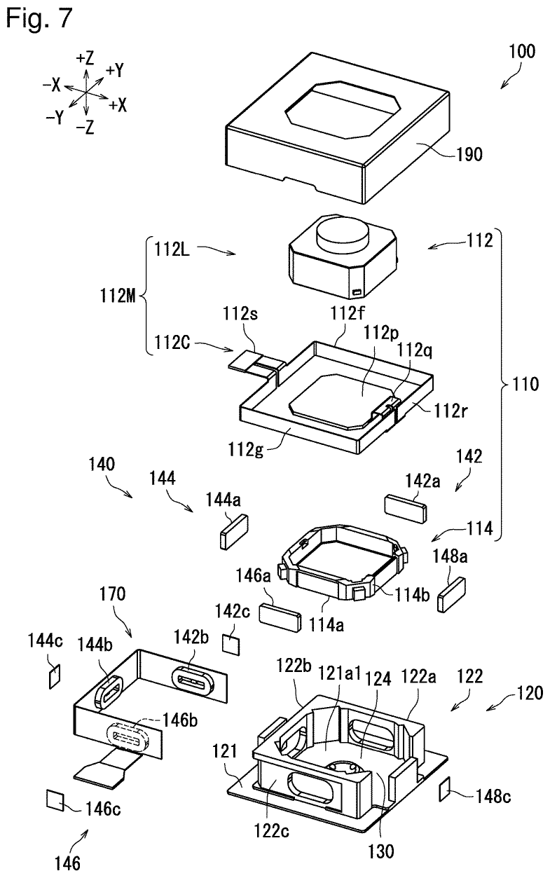

Next, the optical assembly 100 according to the present example embodiment will be described with reference to FIGS. 1 to 7. FIG. 7 is a schematic exploded perspective view of the optical assembly 100 of the present example embodiment.

As illustrated in FIG. 7, the optical assembly 100 includes the movable body 110, the fixed body 120, the support mechanism 130, the swing mechanism 140, the circuit board 170, and the cover 190.

The support mechanism 130 supports the movable body 110 with respect to the fixed body 120. The swing mechanism 140 swings the movable body 110 with respect to the fixed body 120. According to the optical assembly 100 of the present example embodiment, since the support mechanism 130 that supports the movable body 110 is arranged inside the swing mechanism 140, the movable body 110 can be stably supported, and the swing resistance of the movable body 110 can be reduced.

Here, the movable body 110 includes the optical element 112 and the holder 114. The holder 114 accommodates the optical element 112.

The holder 114 has a symmetrical structure with respect to the optical axis Pa when viewed from the Z direction. With the above configuration, it is possible to equalize bending of the holder 114 when the optical assembly 100 receives an impact.

The optical element 112 includes a camera module 112M. The camera module 112M includes a lens assembly 112L and the circuit board 112C. An imaging element is built in the lens assembly 112L. The circuit board 112C has a plurality of wirings. The plurality of wirings are insulated from each other. The circuit board 112C transmits a signal generated in the imaging element. Further, the circuit board 112C transmits a signal for driving the imaging element. A part of the circuit board 112C is arranged between the lens assembly 112L and the holder 114.

As described above, the optical element 112 includes the camera module 112M. The camera module 112M includes the lens assembly 112L and the circuit board 112C electrically connected to the lens assembly 112L. The circuit board 112C faces the upper surface 114a1 of the bottom portion 114a of the holder 114. For this reason, even if the optical assembly 100 receives an impact, contact of the bottom portion 114a of the holder 114 with the circuit board 112C can be suppressed.

The circuit board 112C includes a flat portion 112p, an extended portion 112q, a peripheral portion 112r, and an external terminal connection portion 112s. The flat portion 112p and the peripheral portion 112r are electrically connected. An external terminal is connected to the external terminal connection portion 112s. The imaging signal acquired by the optical element 112 is output to the external terminal by the circuit board 112C.

The flat portion 112p has a thin plate shape extending in the XY plane. The lens assembly 112L is arranged on the +Z direction side of the flat portion 112p. The flat portion 112p is sandwiched between the lens assembly 112L and the holder 114. Note that at least a part of the flat portion 112p is located spaced away from the upper surface 114a1 of the bottom portion 114a of the holder 114.

The extended portion 112q is located on the +X direction side with respect to the flat portion 112p. The extended portion 112q connects the flat portion 112p and the peripheral portion 112r.

The peripheral portion 112r connects the extended portion 112q and the external terminal connection portion 112s. The peripheral portion 112r surrounds the flat portion 112p. The peripheral portion 112r linearly surrounds the periphery of the flat portion 112p. The peripheral portion 112r branches to surround the flat portion 112p.

The peripheral portion 112r has a first wiring portion 112g and a second wiring portion 112h. The first wiring portion 112g is located on the +Y direction side with respect to the flat portion 112p. The second wiring portion 112h is located on the −Y direction side with respect to the flat portion 112p.

An external terminal is connected to the external terminal connection portion 112s. A signal from the imaging element and power to the imaging element can be input and output by the external terminal. The external terminal connection portion 112s is located on the −X direction side of the flat portion 112p. The external terminal connection portion 112s is connected to an end portion of the first wiring portion 112g. Further, the external terminal connection portion 112s is connected to an end portion of the second wiring portion 112h.

The fixed body 120 has a bottom portion 121 and a side portion 122. The bottom portion 121 extends in an XY plane. The bottom portion 121 has a thin plate shape. The side portion 122 protrudes from the bottom portion 121 in the +Z direction.

The side portion 122 includes a first side portion 122a, a second side portion 122b, and a third side portion 122c. When the movable body 110 is mounted on the fixed body 120, the first side portion 122a, the second side portion 122b, and the third side portion 122c are located around the movable body 110. The second side portion 122b is connected to the first side portion 122a, and the third side portion 122c is connected to the second side portion 122b.

The first side portion 122a is located in the +Y direction with respect to the movable body 110. A through hole is provided in the first side portion 122a. The second side portion 122b is located in the −X direction with respect to the movable body 110. A through hole is provided in the second side portion 122b. The third side portion 122c is located in the −Y direction with respect to the movable body 110. A through hole is provided in the third side portion 122c.

As described above, in a case where the movable body 110 is mounted on the fixed body 120, three sides of the movable body 110 are surrounded by the first side portion 122a, the second side portion 122b, and the third side portion 122c. In contrast, no side portion is provided on the +X direction side of the movable body 110. However, a side portion may be provided on the +X direction side of the movable body 110.

The support mechanism 130 supports the movable body 110. The support mechanism 130 is arranged on the fixed body 120. Here, the support mechanism 130 supports the movable body 110 from the same circumference.

The swing mechanism 140 swings the movable body 110 with respect to the fixed body 120. With the swing mechanism 140, the movable body 110 swings with respect to the fixed body 120 in a state where a rotation center of the movable body 110 is fixed on the optical axis Pa.

The swing mechanism 140 swings the movable body 110 with respect to the fixed body 120. The swing mechanism 140 can swing the movable body 110 with respect to the fixed body 120. For example, by the swing mechanism 140, the movable body 110 swings with respect to the fixed body 120. At this time, a rotation center of the movable body 110 is on the optical axis Pa.

The swing mechanism 140 includes a first swing mechanism 142, a second swing mechanism 144, and a third swing mechanism 146. The first swing mechanism 142, the second swing mechanism 144, and the third swing mechanism 146 swing the movable body 110 around different axes with respect to the fixed body 120.

The first swing mechanism 142 swings the movable body 110 with respect to the fixed body 120. The first swing mechanism 142 swings the movable body 110 around the X-axis in a state where the rotation center of the movable body 110 is fixed in the XZ plane. Here, the X-axis direction is an axis of rotation in the yawing direction. The first swing mechanism 142 is located on the +Y direction side of the movable body 110.

The first swing mechanism 142 includes a magnet 142a and a coil 142b. The magnet 142a is magnetized such that the magnetic pole of a surface facing radially outward is different on either side of a magnetization polarization line extending along the X-axis direction. An end portion on a first side along the Z-axis direction of the magnet 142a has a first polarity, and an end portion on a second side has a second polarity.

The magnet 142a is arranged on the +Y direction side of the side portion 114b of the holder 114. The coil 142b is arranged on the circuit board 170. The coil 142b is located in a through hole penetrating the first side portion 122a of the fixed body 120.

By controlling the direction and the magnitude of the current flowing through the coil 142b, the direction and the magnitude of a magnetic field generated from the coil 142b can be changed. Hence, the first swing mechanism 142 swings the movable body 110 around the X-axis by the interaction between the magnetic field generated from the coil 142b and the magnet 142a.

The second swing mechanism 144 swings the movable body 110 with respect to the fixed body 120. The second swing mechanism 144 swings the movable body 110 around the Y-axis in a state where the rotation center of the movable body 110 is fixed in a YZ plane. Here, the Y-axis direction is an axis of rotation in the pitching direction. The second swing mechanism 144 is located on the −X direction side of the movable body 110.

The second swing mechanism 144 includes a magnet 144a and a coil 144b. The magnet 144a is magnetized such that the magnetic pole of a surface facing radially outward is different on either side of a magnetization polarization line extending along the Y-axis direction. An end portion on a first side along the Z-axis direction of the magnet 144a has a first polarity, and an end portion on a second side has a second polarity.

The magnet 144a is arranged on the −X direction side of the side portion 114b of the holder 114. The coil 144b is arranged on the circuit board 170. The coil 144b is located in a through hole penetrating the second side portion 122b of the fixed body 120.

By controlling the direction and the magnitude of the current flowing through the coil 144b, the direction and the magnitude of a magnetic field generated from the coil 144b can be changed. Hence, the second swing mechanism 144 swings the movable body 110 around the Y-axis by the interaction between the magnetic field generated from the coil 144b and the magnet 144a.

The third swing mechanism 146 swings the movable body 110 with respect to the fixed body 120. Specifically, the third swing mechanism 146 swings the movable body 110 around the Z-axis in a state where the rotation center of the movable body 110 is fixed in the XZ plane. Here, the Z-axis direction is parallel to the optical axis Pa and is an axis of rotation in the rolling direction. The third swing mechanism 146 is located on the −Y direction side of the movable body 110.

The third swing mechanism 146 includes a magnet 146a and a coil 146b. The magnet 146a is magnetized such that the magnetic pole of a surface facing radially outward is different on either side of a magnetization polarization line extending along the Z-axis direction. An end portion on a first side along the X-axis direction of the magnet 146a has a first polarity, and an end portion on a second side has a second polarity.

The magnet 146a is arranged on the −Y direction side of the side portion 114b of the holder 114. The coil 146b is arranged on the circuit board 170. The coil 146b is located in a through hole penetrating the third side portion 122c of the fixed body 120.

By controlling the direction and the magnitude of the current flowing through the coil 146b, the direction and the magnitude of a magnetic field generated from the coil 146b can be changed. Hence, the third swing mechanism 146 swings the movable body 110 around the Z-axis by the interaction between the magnetic field generated from the coil 146b and the magnet 146a.

Note that, in the present description, the magnet 142a, the magnet 144a, and the magnet 146a may be collectively referred to as a magnet 140a. In addition, in the present description, the coil 142b, the coil 144b, and the coil 146b may be collectively referred to as a coil 140b.

The swing mechanism 140 includes the magnet 140a provided on the movable body 110 and the coil 140b provided on the fixed body 120. Here, the magnet 140a is arranged on the movable body 110, and the coil 140b is arranged on the fixed body 120. However, the magnet 140a may be arranged on the fixed body 120, and the coil 140b may be arranged on the movable body 110. As described above, a first one of the magnet 140a and the coil 140b may be arranged on a first one of the movable body 110 and the fixed body 120, and a second one of the magnet 140a and the coil 140b may be arranged on a second one of the movable body 110 and the fixed body 120. By controlling the direction and the magnitude of the current flowing through the coil 140b, the direction and the magnitude of a magnetic field generated from the coil 140b can be changed. For this reason, the swing mechanism 140 can swing the movable body 110 by the interaction between the magnetic field generated from the coil 140b and the magnet 140a.

The optical assembly 100 further includes a magnetic body 142c, a magnetic body 144c, and a magnetic body 146c. The magnetic body 142c, the magnetic body 144c, and the magnetic body 146c are arranged on the circuit board 170. The magnetic body 142c is arranged facing the coil 142b on the circuit board 170. The magnetic body 144c is arranged facing the coil 144b on the circuit board 170. The magnetic body 146c is arranged facing the coil 146b on the circuit board 170. The magnetic body 142c, the magnetic body 144c, and the magnetic body 146c may be hard magnetic bodies.

The optical assembly 100 further includes a magnet 148a and a magnetic body 148c. The magnet 148a is arranged on the +X direction side of the side portion 114b of the holder 114. The magnetic body 148c is arranged on the +X direction side of the fixed body 120. The magnet 148a and the magnetic body 148c face each other. The magnetic body 148c may be a hard magnetic body.

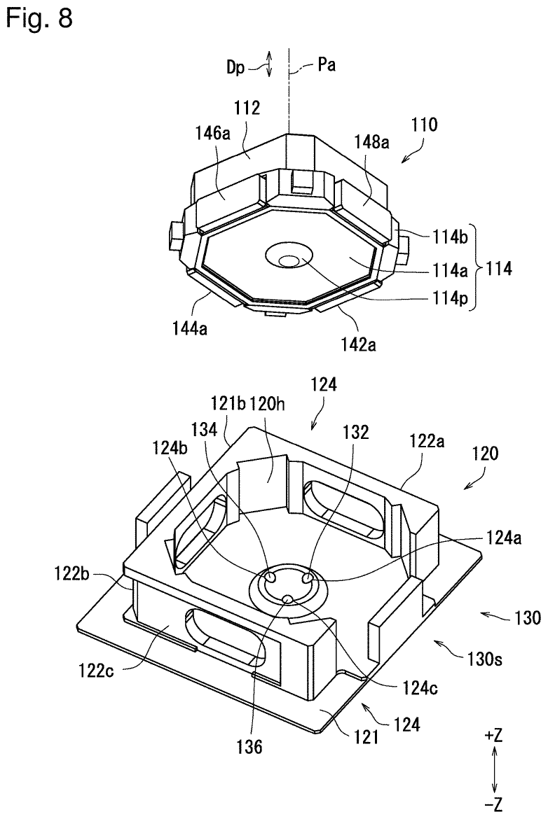

Next, the optical assembly 100 according to the present example embodiment will be described with reference to FIGS. 1 to 8. FIG. 8 is a schematic exploded view of the movable body 110 and the fixed body 120 in the optical assembly 100 of the present example embodiment. Note that, in FIG. 8, the circuit board 112C of the movable body 110 is omitted for the purpose of preventing the diagram from being excessively complicated.

As illustrated in FIG. 8, the movable body 110, the optical element 112, and the holder 114 are included. The holder 114 includes the bottom portion 114a, the side portion 114b, and the protrusion 114p. The bottom portion 114a extends in the XY plane. The bottom portion 114a has a substantially rectangular parallelepiped shape. The side portion 114b protrudes in the +Z direction from an outer edge of the bottom portion 114a. The protrusion 114p protrudes from the bottom portion 114a of the holder 114 in the optical axis direction Dp in which the optical axis Pa extends. The protrusion 114p has a hemispherical shape. The protrusion 114p is located at the center of the lower surface 114a2 of the bottom portion 114a of the holder 114.

The movable body 110 is accommodated in the fixed body 120. The support mechanism 130 is arranged on the fixed body 120. The support mechanism 130 supports the movable body 110. The support mechanism 130 comes into contact with the protrusion 114p of the holder 114 to support the movable body 110.

The fixed body 120 includes the bottom portion 121, the side portion 122, and the recess 124 recessed in the optical axis direction Dp with respect to the bottom portion 121. The support mechanism 130 is arranged on the fixed body 120. The support mechanism 130 is arranged in the recess 124 of the fixed body 120. The recess 124 faces the protrusion 114p of the holder 114.

The recess 124 includes a first recess 124a, a second recess 124b, and a third recess 124c. The first recess 124a, the second recess 124b, and the third recess 124c are arranged at equal intervals on the same circumference around the optical axis Pa. In the present description, the first recess 124a, the second recess 124b, and the third recess 124c may be collectively referred to as the recess 124.

The support mechanism 130 supports the movable body 110. The support mechanism 130 is arranged on the fixed body 120. The support mechanism 130 is located between the recess 124 of the fixed body 120 and the protrusion 114p of the holder 114.

The support mechanism 130 protrudes from the bottom portion 121 of the fixed body 120 toward the protrusion 114p of the holder 114. Even when the movable body 110 swings with respect to the fixed body 120, it is possible to suppress collision of the movable body 110 with the fixed body 120.

The support mechanism 130 includes a plurality of support portions 130s. The plurality of support portions 130s have the same shape. Here, the support mechanism 130 includes a first support portion 132, a second support portion 134, and a third support portion 136. In the present description, the first support portion 132, the second support portion 134, and the third support portion 136 may be collectively referred to as the support portion 130s.

The first support portion 132, the second support portion 134, and the third support portion 136 are arranged in the first recess 124a, the second recess 124b, and the third recess 124c, respectively. For this reason, the first support portion 132, the second support portion 134, and the third support portion 136 are arranged at equal intervals on the same circumference around the optical axis Pa. For this reason, the movable body 110 can be stably supported with respect to the fixed body 120.

The first support portion 132, the second support portion 134, and the third support portion 136 have a spherical shape or a shape of a part of a spherical surface. A portion of a spherical surface shape of the first support portion 132, the second support portion 134, and the third support portion 136 comes into contact with the protrusion 114p of the holder 114, so that the movable body 110 can slide with respect to the support mechanism 130.

The bottom portion 114a of the holder 114 has the protrusion 114p protruding in the optical axis direction Dp. The support mechanism 130 includes the plurality of support portions 130s arranged on the same circumference with respect to the optical axis Pa. The plurality of support portions 130s are located radially outside with respect to the protrusion 114p of the holder 114. The optical element 112 can be sufficiently supported by the support portions 130s arranged on the same circumference.

The support portion 130s has a shape of a spherical surface or a part of a spherical surface. For this reason, the movable body 110 can be slid by the support portion 130s.

Note that, in FIG. 8, the protrusion 114p is provided on the bottom portion 114a of the holder 114. However, as illustrated in FIG. 5B, a recess 114q may be provided on the bottom portion 114a of the holder 114. In this case, when viewed in the optical axis direction Dp, the recess 114q preferably overlaps the plurality of support portions 130s. In this manner, even in a case where the optical assembly 100 receives an impact, contact of the plurality of support portions 130s with the holder 114 can be suppressed.

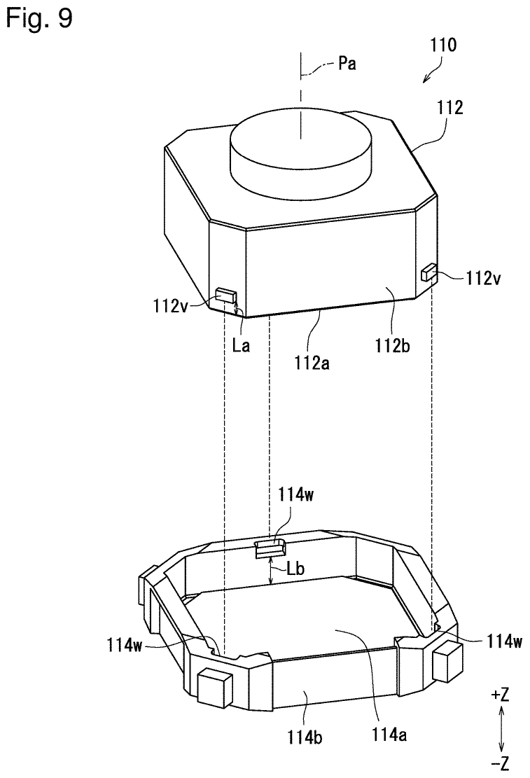

Next, the optical assembly 100 according to the present example embodiment will be described with reference to FIGS. 1 to 9. FIG. 9 is a schematic exploded perspective view of the optical element 112 and the holder 114 in the optical assembly 100 of the present example embodiment.

As illustrated in FIG. 9, the optical element 112 is accommodated in the holder 114. An outer peripheral surface of the optical element 112 faces an inner peripheral surface of the holder 114. In a case where the optical element 112 is accommodated in the holder 114, the bottom surface 112a of the optical element 112 is located spaced away from the upper surface 114a1 of the bottom portion 114a of the holder 114.

A projection portion 112v is provided on the side surface 112b of the optical element 112. The projection portion 112v protrudes radially outward from the side surface 112b. Here, the projection portions 112v are provided at equal intervals in three directions from the side surface 112b when viewed from the optical axis Pa. The projection portion 112v is located at a position away from the bottom surface 112a of the optical element 112 by a length La along the Z-axis direction.

A cavity 114w is provided on the side portion 114b of the holder 114. The cavity 114w is recessed radially outward from an inner peripheral surface of the side portion 114b of the holder 114. The size of the cavity 114w is substantially equal to or slightly larger than that of the projection portion 112v. Here, when viewed from the optical axis Pa, the cavities 114w are provided at equal intervals in three directions from the inner peripheral surface of the side portion 114b. The cavity 114w is located at a position higher by a length Lb along the Z-axis direction than the upper surface 114a1 of the bottom portion 114a of the holder 114.

By fitting the projection portion 112v of the optical element 112 into the cavity 114w of the holder 114, the optical element 112 can be mounted on the holder 114. The bottom surface 112a of the optical element 112 is located spaced away from the upper surface 114a1 of the bottom portion 114a of the holder 114.

The length La between the projection portion 112v of the optical element 112 and the bottom surface 112a of the optical element 112 is smaller than the length Lb between the cavity 114w of the holder 114 and the upper surface 114a1 of the bottom portion 114a. For this reason, when the optical element 112 is mounted on the holder 114, the bottom surface 112a of the optical element 112 is not in contact with the upper surface 114a1 of the bottom portion 114a of the holder 114, and the optical element 112 is supported by the side portion 114b of the holder 114.

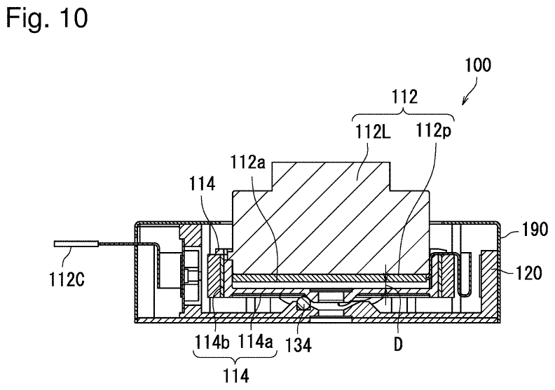

Next, the optical assembly 100 according to the present example embodiment will be described with reference to FIGS. 1 to 11. FIG. 10 is a schematic cross-sectional view of the optical assembly 100 of the present example embodiment taken along line X-X in FIG. 6B. Note that, although only the second support portion 134 is illustrated in FIG. 10, the same applies to the first support portion 132 and the third support portion 136.

As illustrated in FIG. 10, in the optical element 112, the lens assembly 112L overlaps the flat portion 112p. For example, the lens assembly 112L is bonded to the flat portion 112p. Therefore, a bottom surface of the flat portion 112p becomes the bottom surface 112a of the optical element 112.

The bottom surface 112a of the optical element 112 is located spaced away from the upper surface 114a1 of the bottom portion 114a of the holder 114. There is a gap D between the bottom surface 112a of the optical element 112 and the upper surface 114a1 of the bottom portion 114a of the holder 114. The gap D corresponds to a difference between the length Lb between the cavity 114w in the holder 114 illustrated in FIG. 10 and the upper surface 114a1 of the bottom portion 114a and the length La between the projection portion 112v in the optical element 112 and the bottom surface 112a of the optical element 112.

In the optical assembly 100 of the present example embodiment, the gap D between the optical element 112 and the holder 114 is provided in a portion facing the second support portion 134 via the holder 114. For this reason, when the optical assembly 100 receives an impact, the holder 114 can be bent, so that an impact between the holder 114 and the second support portion 134 can be reduced.

Note that, in a case where the gap D is too small, if an impact received by the optical assembly 100 is large, the holder 114 that is bent may collide with the optical element 112. For this reason, as the gap D is larger, an impact between the holder 114 and the second support portion 134 can be reduced. In contrast, if the gap D is too large, the position of the optical element 112 in the +Z direction becomes large, and it becomes difficult to downsize the optical assembly 100. In one example, a preferable length of the gap D is 0.1 mm or more and 0.5 mm or less.

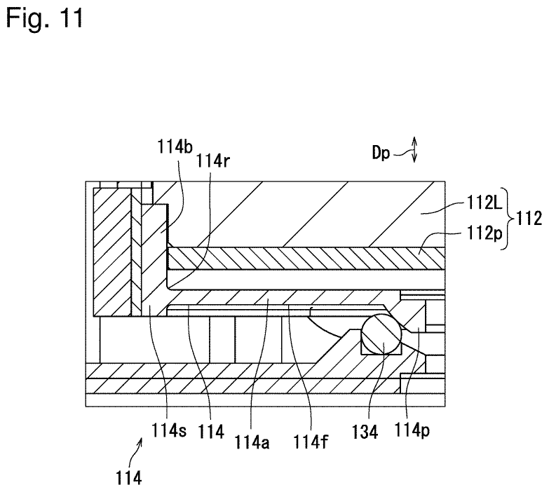

FIG. 11 is an enlarged view of a part of FIG. 10. The bottom portion 114a of the holder 114 has the protrusion 114p and a flat plate portion 114f. The flat plate portion 114f is located on the radially outside the protrusion 114p. The flat plate portion 114f is located between the protrusion 114p and the side portion 114b.

In this manner, the bottom portion 114a of the holder 114 further includes the flat plate portion 114f having a uniform thickness. The flat plate portion 114f allows the bottom portion 114a of the holder 114 to be easily bent, and an impact on a contact portion between the bottom portion 114a of the holder 114 and the support mechanism 130 can be reduced.

Further, the flat plate portion 114f is located on the radially outer side than the protrusion 114p of the bottom portion 114a. Note that the flat plate portion 114f may be located on the radially outer side than the cavity 114d (FIG. 5B) of the bottom portion 114a. In this case, the bottom portion 114a of the holder 114 is easily bent, and an impact on a contact portion between the bottom portion 114a of the holder 114 and the support mechanism 130 can be reduced.

Further, a curved portion 114r is provided between the flat plate portion 114f and the side portion 114b on the bottom portion 114a of the holder 114. As described above, the bottom portion 114a of the holder 114 further includes the curved portion 114r that connects the flat plate portion 114f and the side portion 114b of the holder 114 in a curved manner. With the above configuration, the strength of the flat plate portion 114f can be improved by the curved portion 114r.

Further, the bottom portion 114a of the holder 114 is provided with an outer peripheral protrusion 114s protruding from the side portion 114b along the optical axis direction Dp. The outer peripheral protrusion 114s protrudes from the bottom portion 114a along the optical axis direction Dp.

As described above, the bottom portion 114a of the holder 114 further includes the outer peripheral protrusion 114s protruding from the side portion 114b in the optical axis direction Dp. With the above configuration, the strength of the bottom portion 114a of the holder 114 can be improved by the outer peripheral protrusion 114s.

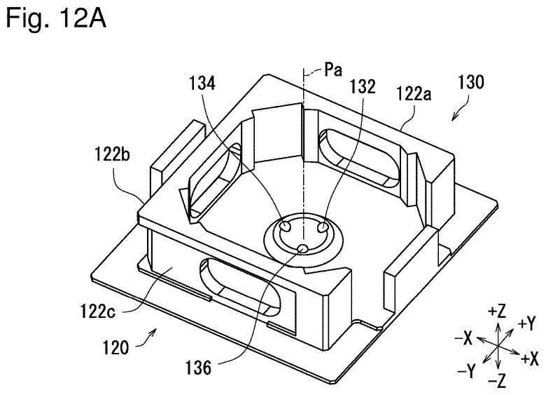

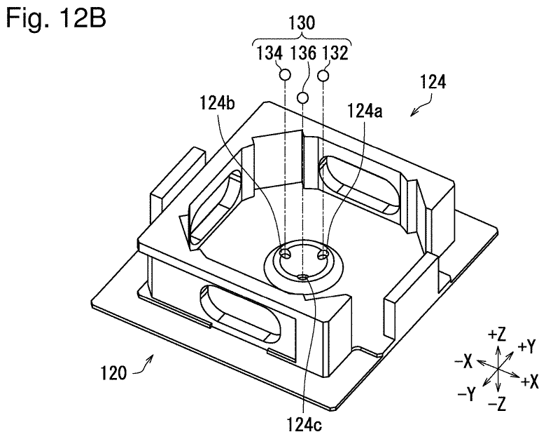

Next, the optical assembly 100 according to the present example embodiment will be described with reference to FIGS. 1 to 12B. FIG. 12A is a schematic perspective view of the fixed body 120 and the support mechanism 130 in the optical assembly 100 according to the present example embodiment. FIG. 12B is a schematic exploded view of the fixed body 120 in the optical assembly 100 of the present example embodiment.

As illustrated in FIG. 12A, the first support portion 132, the second support portion 134, and the third support portion 136 are arranged on the fixed body 120. The first support portion 132, the second support portion 134, and the third support portion 136 are located on the same circumference around the optical axis Pa. The first support portion 132, the second support portion 134, and the third support portion 136 have a spherical shape.

As illustrated in FIG. 12B, an inner peripheral surface 120s of the fixed body 120 is provided with a recess 124. The recess 124 is provided corresponding to a plurality of the support mechanisms 130. Specifically, the recess 124 includes the first recess 124a corresponding to the first support portion 132, the second recess 124b corresponding to the second support portion 134, and the third recess 124c corresponding to the third support portion 136.

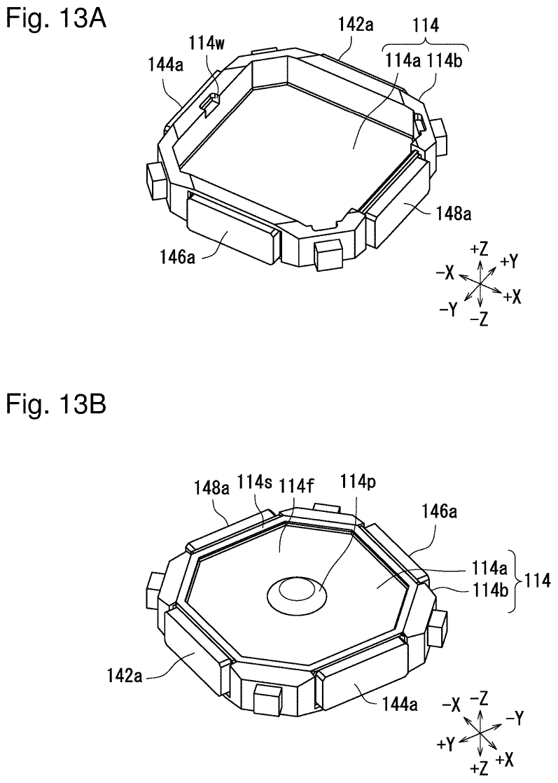

Next, the optical assembly 100 according to the present example embodiment will be described with reference to FIGS. 1 to 13B. FIGS. 13A and 13B are schematic perspective views of the holder 114 in the optical assembly 100 of the present example embodiment. FIG. 13A is a schematic perspective view of the holder 114 as viewed from the +Z direction, and FIG. 13B is a schematic perspective view of the holder 114 as viewed from the −Z direction.

As illustrated in FIGS. 13A and 13B, the holder 114 has the bottom portion 114a and the side portion 114b. The side portion 114b surrounds the side of the bottom portion 114a. The cavity 114w is provided on an upper surface (+Z direction side) of the side portion 114b.

The bottom portion 114a of the holder 114 is provided with the protrusion 114p, the flat plate portion 114f, and the outer peripheral protrusion 114s. The protrusion 114p protrudes in the −Z direction from the bottom portion 114a of the holder 114. The flat plate portion 114f is provided radially outside the protrusion 114p. The outer peripheral protrusion 114s is provided radially outside the flat plate portion 114f.

Note that, in the holder 114 illustrated in FIGS. 3A to 13B, the radial outside of the protrusion 114p is flat. However, the present example embodiment is not limited to this configuration. The radial outside of the protrusion 114p does not need to be flat.

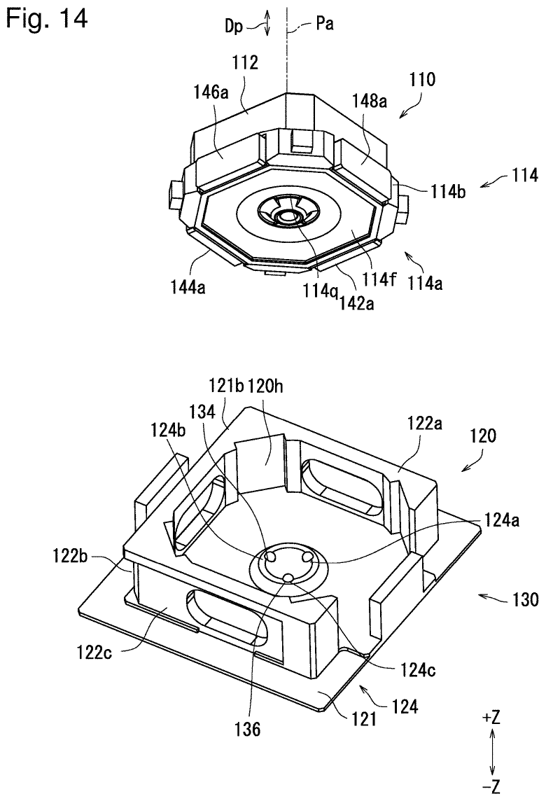

Next, the optical assembly 100 according to the present example embodiment will be described with reference to FIGS. 1 to 14. FIG. 14 is a schematic perspective view of the holder 114 in the optical assembly 100 of the present example embodiment.

As illustrated in FIG. 14, the holder 114 includes the bottom portion 114a and the side portion 114b. The bottom portion 114a has the protrusion 114p, the flat plate portion 114f, and the recess 114q. The recess 114q is provided on the lower surface 114a2 of the bottom portion 114a. For example, the recess 114q is recessed in the +Z direction with respect to the flat plate portion 114f. Alternatively, the recess 114q may be a through hole of the bottom portion 114a.

The recess 114q is located radially outside the protrusion 114p. The recess 114q is arranged corresponding to the first support portion 132 to the third support portion 136 arranged on the fixed body 120. The recess 114q can suppress collision of the first support portion 132 to the third support portion 136 with the bottom portion 114a of the holder 114.

Further, the recess 114q is provided on the bottom portion 114a of the holder 114. Since the recess 114q is provided on the bottom portion 114a of the holder 114, the bottom portion 114a of the holder 114 can be easily bent.

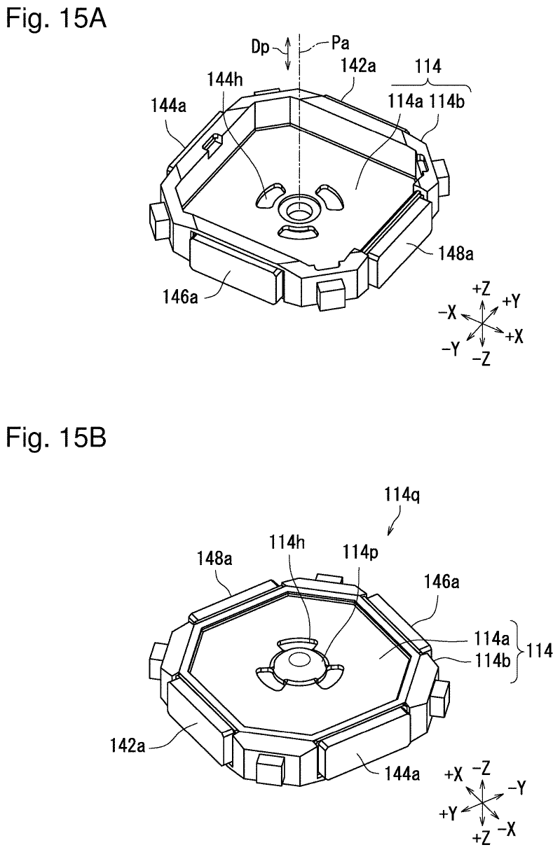

Next, the optical assembly 100 according to the present example embodiment will be described with reference to FIGS. 1 to 15B. FIGS. 15A and 15B are schematic perspective views of the holder 114 in the optical assembly 100 of the present example embodiment. FIG. 15A is a schematic perspective view of the holder 114 as viewed from the +Z direction, and FIG. 15B is a schematic perspective view of the holder 114 as viewed from the −Z direction.

As illustrated in FIGS. 15A and 15B, the holder 114 has the bottom portion 114a and the side portion 114b. The bottom portion 114a has the protrusion 114p, the flat plate portion 114f, and a through hole 114h. The through hole 114h is provided on the lower surface 114a2 of the bottom portion 114a. The through hole 114h may be a through hole of the bottom portion 114a.

The through hole 114h is located radially outside the protrusion 114p. The through hole 114h is arranged corresponding to the first support portion 132 to the third support portion 136 arranged in the fixed body 120. The through hole 114h can suppress collision of the first support portion 132 to the third support portion 136 with the bottom portion 114a of the holder 114.

The recess 114q includes the through hole 114h penetrating the bottom portion 114a of the holder 114. With the through hole 114h, even in a case where the optical assembly 100 receives an impact, contact of the plurality of support portions 130s with the holder 114 can be suppressed.

The through holes 114h extend radially about the optical axis Pa from the periphery of the optical axis Pa. Since the through holes 114h of the bottom portion 114a of the holder 114 radially extend about the optical axis Pa, the bottom portion 114a of the holder 114 can be uniformly bent, and an impact on a contact portion between the bottom portion 114a of the holder 114 and the support mechanism 130 can be reduced.

Note that, in the optical assembly 100 illustrated in FIGS. 3 to 15, there is a space between the movable body 110 (circuit board 112C) and the holder 114. However, the present example embodiment is not limited to this configuration. A member may be arranged between the movable body 110 (circuit board 112C) and the holder 114.

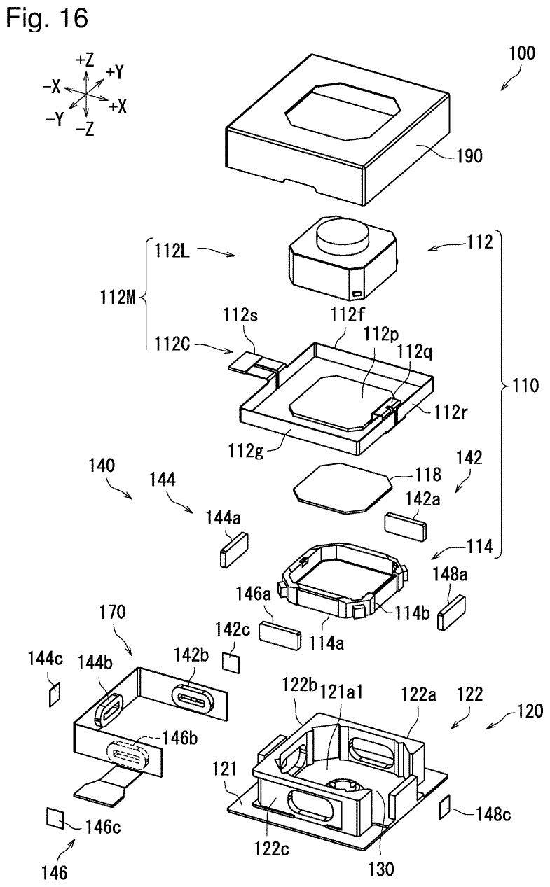

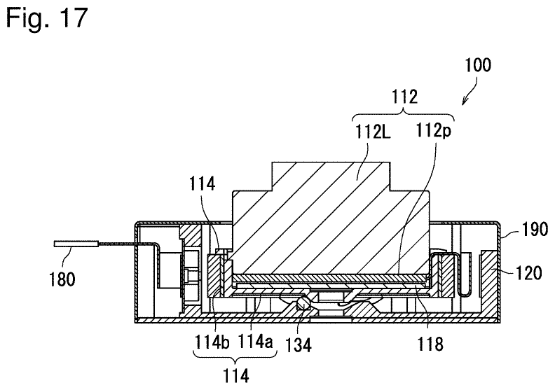

Next, the optical assembly 100 of the present example embodiment will be described with reference to FIGS. 1 to 17. FIG. 16 is a schematic exploded perspective view of the optical assembly 100 of the present example embodiment, and FIG. 17 is a schematic cross-sectional view of the optical assembly 100 of the present example embodiment. The optical assembly 100 in FIGS. 16 and 17 has the same configuration as the optical assembly 100 in FIGS. 7 and 10 except that a buffer 118 is arranged between the circuit board 112C and the holder 114, and redundant description is omitted in order to avoid redundancy.

As illustrated in FIGS. 16 and 17, the optical assembly 100 further includes the buffer 118 located between the bottom portion 114a of the holder 114 and the optical element 112. The buffer 118 can move with respect to the fixed body 120 together with the optical element 112 and the holder 114. For this reason, the buffer 118 is a part of the movable body 110.

The buffer 118 is made from an elastic material. An elastic modulus of the buffer 118 is higher than an elastic modulus of the optical element 112 and the holder 114. Specifically, the elastic modulus of the buffer 118 is higher than an elastic modulus of portions of the optical element 112 and the holder 114 facing each other. For example, the buffer 118 is made from silicone or rubber.

As the buffer 118, a sheet-like member may be attached to one of the optical element 112 and the holder 114.

Alternatively, the buffer 118 may be made by applying a material of the buffer 118 to one of the optical element 112 and the holder 114.

Since the buffer 118 is located between the bottom portion 114a of the holder 114 and the optical element 112, even if the bottom portion 114a of the holder 114 is deformed, it is possible to suppress transmission of an impact to the optical element 112, and it is possible to reduce an impact on a contact portion between the bottom portion 114a of the holder 114 and the support mechanism 130.

The buffer 118 is arranged spaced away from at least one of the bottom portion 114a of the holder 114 and the optical element 112. Since the buffer 118 is arranged spaced away from at least one of the bottom portion 114a of the holder 114 and the optical element 112, it is possible to reduce an impact of a contact portion between the bottom portion 114a of the holder 114 and the support mechanism 130.

Typically, a thickness (length along the Z-axis direction) of the buffer 118 is smaller than the gap D between the movable body 110 (circuit board 112C) and the holder 114. For example, there may be a gap between the circuit board 112C and the buffer 118, and there may be a gap between the buffer 118 and the holder 114. Alternatively, while the circuit board 112C and the buffer 118 are in contact with each other, there may be a gap between the buffer 118 and the holder 114. Alternatively, while the buffer 118 and the holder 114 are in contact with each other, there may be a gap between the circuit board 112C and the buffer 118.

However, the thickness (length along the Z-axis direction) of the buffer 118 may be equal to the gap D between the movable body 110 (circuit board 112C) and the holder 114. In this case, the circuit board 112C and the buffer 118 may be in contact with each other, and the buffer 118 may be in contact with the holder 114.

Note that, in the above description with reference to FIGS. 5 to 17, the movable body 110 and the fixed body 120 have a substantially square shape when viewed from the Z direction. However, the present example embodiment is not limited to this configuration. The movable body 110 and the fixed body 120 may have a rectangular shape extending in one direction when viewed from the Z direction.

Further, in the above description with reference to FIGS. 5 to 17, the circuit board 112C surrounds the movable body 110. However, the present example embodiment is not limited to this configuration. The circuit board 112C does not need to surround the movable body 110.

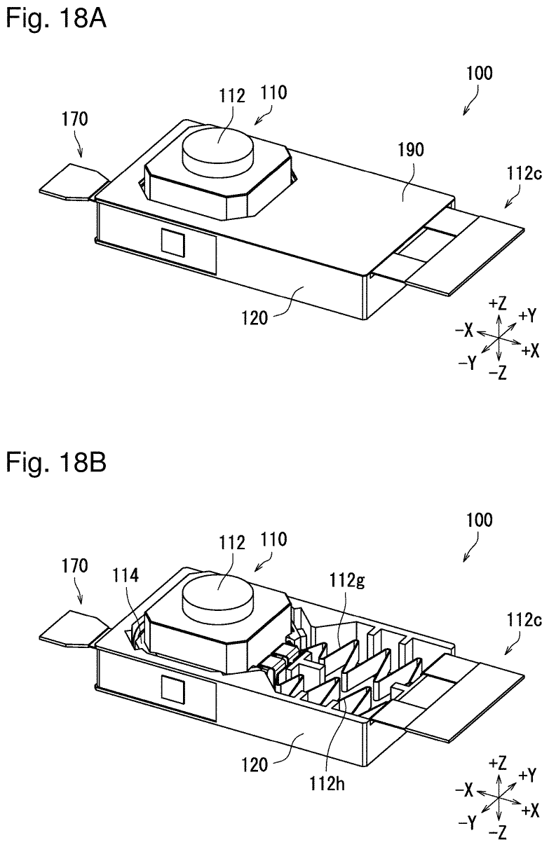

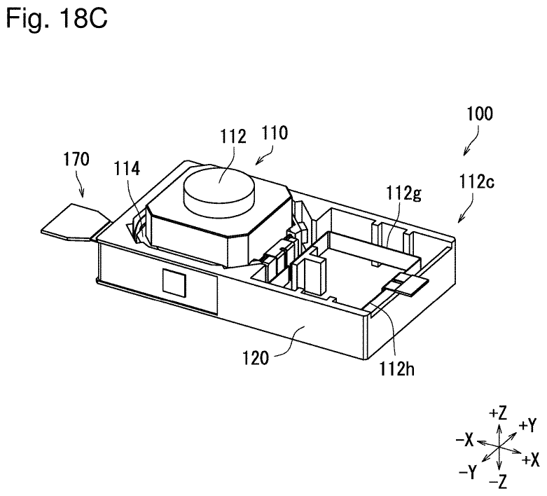

Next, the optical assembly 100 according to the present example embodiment will be described with reference to FIGS. 18A and 18B. FIGS. 18A and 18B are schematic perspective views of the optical assembly 100 of the present example embodiment. Note that, in FIG. 18B, the cover 190 that covers the fixed body 120 is omitted from illustration for the purpose of preventing the diagram from being excessively complicated.

As illustrated in FIGS. 18A and 18B, the optical assembly 100 includes the movable body 110, the fixed body 120, the support mechanism 130, the swing mechanism 140, and the circuit board 170. Here, the fixed body 120 extends in the X-axis direction. The cover 190 is located on the +Z direction side with respect to the fixed body 120. The cover 190 covers an opening portion of the fixed body 120. The circuit board 170 or the circuit board 112C includes, for example, a flexible printed circuit.

The circuit board 112C extends in the X direction. The circuit board 112C extends in the +X direction with respect to the fixed body 120 and the cover 190.

The circuit board 170 extends in the X direction. The circuit board 170 extends in the −X direction with respect to the fixed body 120 and the cover 190. The coils 142b, 144b, and 146b are attached to the circuit board 170.

The fixed body 120 accommodates the circuit board 112C together with the movable body 110. The circuit board 112C is separated into two. The circuit board 112C includes the first wiring portion 112g and the second wiring portion 112h. The first wiring portion 112g and the second wiring portion 112h may be configured from a single circuit board or may be configured from different circuit boards.

The first wiring portion 112g and the second wiring portion 112h have a symmetrical structure. When viewed from the Z direction, the first wiring portion 112g and the second wiring portion 112h are symmetrical. Each of the first wiring portion 112g and the second wiring portion 112h has a bent portion bent in the Y direction. The circuit board 112C has a bellows structure.

Note that, in the optical assembly 100 illustrated in FIG. 18B, the circuit board 112C has a bellows structure. However, the present example embodiment is not limited to this configuration.

Next, the optical assembly 100 of the present example embodiment will be described with reference to FIGS. 18A to 18C. FIG. 18C is a schematic perspective view of the optical assembly 100 of the present example embodiment. In FIG. 18C, the circuit board 170 is omitted together with the cover 190 covering the fixed body 120 in order to avoid the diagram from being excessively complicated.

As illustrated in FIG. 18C, the optical assembly 100 includes the movable body 110, the fixed body 120, the support mechanism 130, the swing mechanism 140, and the circuit board 170. Here, the fixed body 120 extends in the X-axis direction. The cover 190 is located on the +Z direction side with respect to the fixed body 120. The cover 190 covers an opening portion of the fixed body 120. The circuit board 112C and the circuit board 170 include, for example, a flexible circuit board.

The circuit board 112C extends in the X direction. The circuit board 112C extends in the +X direction with respect to the fixed body 120 and the cover 190.

The circuit board 170 extends in the X direction. The circuit board 170 extends in the −X direction with respect to the fixed body 120 and the cover 190. The coils 142b, 144b, and 146b are attached to the circuit board 170.

The fixed body 120 accommodates the circuit board 112C together with the movable body 110. The circuit board 112C is separated into two. The circuit board 112C includes the first wiring portion 112g and the second wiring portion 112h. The first wiring portion 112g and the second wiring portion 112h may be configured from a single circuit board or may be configured from different circuit boards.

The first wiring portion 112g and the second wiring portion 112h have a symmetrical structure. When viewed from the Z direction, the first wiring portion 112g and the second wiring portion 112h are symmetrical.

Note that, in the optical assembly 100 illustrated in FIGS. 2 to 18, the bottom surface 112a of the optical element 112 is located spaced away from the upper surface 114a1 of the bottom portion 114a of the holder 114, so that a space between the bottom surface 112a of the optical element 112 and the upper surface 114a1 of the bottom portion 114a of the holder 114 has what is called a damper function, and a member that constitutes the damper function is arranged in the movable body 110. However, the present example embodiment is not limited to this configuration. A member that constitutes the damper function may be arranged on the fixed body 120.

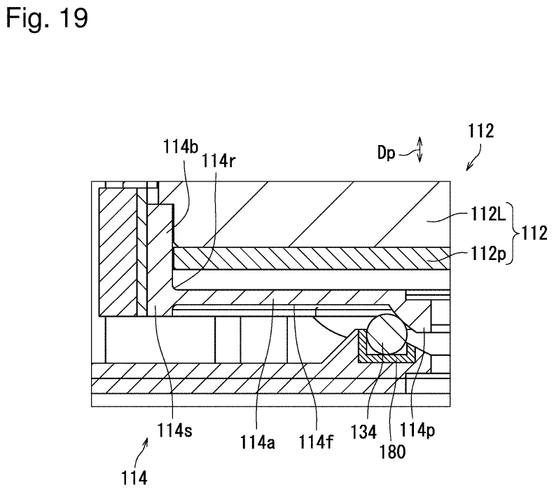

Next, the optical assembly 100 according to the present example embodiment will be described with reference to FIG. 19. FIG. 19 is a schematic cross-sectional view of the optical assembly 100 of the present example embodiment.

As illustrated in FIG. 19, the optical assembly 100 further includes a buffer 180 in addition to the movable body 110, the fixed body 120, the support mechanism 130, and the swing mechanism 140. The buffer 180 is arranged between the fixed body 120 and the support mechanism 130. Specifically, the buffer 180 is arranged on the recess 124 of the fixed body 120 and is located between the fixed body 120 and the support mechanism 130.

According to the optical assembly 100 of the present example embodiment, application of a strong load to a contact portion between the bottom portion 114a of the holder 114 and the support mechanism 130 can be suppressed by the buffer 180, and damage to at least one of the bottom portion 114a of the holder 114 and the support mechanism 130 can be suppressed.

Further, as illustrated in FIG. 19, the bottom surface 112a (bottom surface of flat portion 112p) of the optical element 112 and the upper surface 114a1 of the bottom portion 114a of the holder 114 are separated from each other, so that it is possible to suppress application of a strong load to a contact portion between the bottom portion 114a of the holder 114 and the support mechanism 130.

Note that, in the optical assembly 100 illustrated in FIG. 19, the bottom surface 112a (bottom surface of the flat portion 112p) of the optical element 112 and the upper surface 114a1 of the bottom portion 114a of the holder 114 are separated from each other. However, the present example embodiment is not limited to this configuration. The bottom surface 112a (bottom surface of the flat portion 112p) of the optical element 112 may be in contact with the upper surface 114a1 of the bottom portion 114a of the holder 114. For example, the entire bottom surface 112a (bottom surface of the flat portion 112p) of the optical element 112 may be in contact with the upper surface 114a1 of the bottom portion 114a of the holder 114.

Note that, in the optical assembly 100 and each member of the optical assembly 100 illustrated in FIGS. 2 to 19, the movable body 110 has a substantially thin plate shape. However, the present example embodiment is not limited to this configuration. The movable body 110 may have a substantially spherical shape, and the fixed body 120 may swingably support the movable body 110 according to the shape of the movable body 110.

The smartphone 200 includes the optical assembly 100 of the present example embodiment. The elastic resistance of the circuit board 112C in the smartphone 200 can be reduced.

Note that while FIG. 1 illustrates the smartphone 200 as an example of the application of the optical assembly 100 of the present example embodiment, the application of the optical assembly 100 is not limited to this. The optical assembly 100 is preferably used for a digital camera or a video camera. For example, the optical assembly 100 may be used as a part of a drive recorder. Alternatively, the optical assembly 100 may be mounted on a camera for a flight vehicle (for example, a drone).

The example embodiment of the present disclosure is described above with reference to the drawings. However, the present disclosure is not limited to the above example embodiment, and can be implemented in various modes without departing from the gist of the disclosure. Further, various disclosures are possible by appropriately combining a plurality of constituents disclosed in the above example embodiment. For example, some constituents may be removed from all the constituents described in the example embodiment. Furthermore, constituents across different example embodiments may be combined as appropriate. The constituents in the drawings are mainly and schematically illustrated to facilitate better understanding, and the thickness, length, number, spacing, and the like of each constituent illustrated in the drawings may differ from actual values for the convenience of creating drawings. Additionally, the material, shape, dimension, and the like of each constituent element illustrated in the above example embodiments are mere examples and are not particularly limited, and various modifications can be made without substantially departing from the effects of the present disclosure.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical assembly comprising:
a fixed body;
a movable body movably arranged with respect to the fixed body;
a support mechanism that supports the movable body; and
a swing mechanism that swings the movable body with respect to the fixed body; wherein
the movable body includes an optical element having an optical axis and a holder that holds the optical element;
the holder includes a bottom portion and a side portion;
the support mechanism supports the bottom portion of the holder; and
a bottom surface of the optical element is spaced away from an upper surface of the bottom portion of the holder at a position overlapping the support mechanism in an optical axis direction extending along the optical axis.

2. The optical assembly according to claim 1, wherein the bottom surface of the optical element is spaced away from the upper surface of the bottom portion of the holder radially outside a position overlapping the support mechanism in the optical axis direction.

3. The optical assembly according to claim 1, wherein an entire surface of the bottom surface of the optical element is spaced away from the top surface of the bottom portion of the holder.

4. The optical assembly according to claim 1, wherein
the support mechanism supports the bottom portion of the holder; and
the optical element is supported by the side portion of the holder.

5. The optical assembly according to claim 1, further comprising a buffer between the bottom portion of the holder and the optical element.

6. The optical assembly according to claim 5, wherein the buffer is spaced away from at least one of the bottom portion of the holder and the optical element.

7. The optical assembly according to claim 1, wherein
the bottom portion of the holder includes a protrusion protruding in the optical axis direction or a cavity recessed in the optical axis direction; and
the movable body slides with respect to the fixed body via the support mechanism.

8. The optical assembly according to claim 7, wherein the bottom portion of the holder further includes a flat plate portion having a uniform thickness.

9. The optical assembly according to claim 8, wherein the flat plate portion is located radially outside the protrusion or the cavity of the bottom portion.

10. The optical assembly according to claim 8, wherein the bottom portion of the holder further includes a curved portion connecting the flat plate portion and the side portion of the holder in a curved manner.

11. The optical assembly according to claim 1, wherein the bottom portion of the holder further includes an outer peripheral protrusion protruding from the side portion in the optical axis direction.

12. The optical assembly according to claim 7, wherein a recess is provided on the bottom portion of the holder.

13. The optical assembly according to claim 12, wherein the recess includes a through hole penetrating the bottom portion of the holder.

14. The optical assembly according to claim 13, wherein the through hole extends radially around the optical axis from a periphery of the optical axis.

15. The optical assembly according to claim 14, wherein
the bottom portion of the holder includes a protrusion protruding in the optical axis direction;
the support mechanism includes a plurality of support portions arranged on a same circumference with respect to the optical axis; and
the plurality of support portions are located radially outside the protrusion of the holder.

16. The optical assembly according to claim 15, wherein the recess overlaps the plurality of support portions when viewed in the optical axis direction.

17. The optical assembly according to claim 15, wherein the support portion has a shape of a spherical surface or a shape of a portion of a spherical surface.

18. The optical assembly according to claim 1, wherein the holder has a symmetrical structure with respect to the optical axis.

19. The optical assembly according to claim 1, wherein
the optical element includes a camera module;
the camera module includes a lens assembly and a circuit board electrically connected to the lens assembly; and
the circuit board opposes the upper surface of the bottom portion of the holder.

20. A smartphone comprising the optical assembly according to claim 1.
